(19) United States
(12) Patent Application Publication
(10) Pub. No.: US 2023/0221208 A1
(43) Pub. Date: Jul. 13, 2023

(54) SYSTEMS AND METHODS FOR DETECTING AND PREDICTING A LEAK IN A PIPE SYSTEM

(71) Applicant: Siemens Advanta Solutions Corp., Minnetonka, MN (US)

(72) Inventor: Eduardo Sugay, Hinsdale, IL (US)

(21) Appl. No.: 17/996,174

(22) PCT Filed: Apr. 15, 2021
(86) PCT No.: PCT/US2021/027391

§ 371 Date: Oct. 13, 2022

Related U.S. Application Data
(60) Provisional application No. 63/011,370, filed on Apr. 17, 2020.

(51) Int. Cl. G01M 3/28

(52) U.S. Cl. CPC G01M 3/2807

(57) ABSTRACT

A system for detection or prediction of a leak in a pipe system includes a data source with characteristics of a pipe system, a prediction module, and an interface coupled between the data source and the prediction module, wherein the prediction module includes at least one processor and is configured via executable instructions to receive the characteristics of the pipe system via the interface, evaluate the characteristics of the pipe system utilizing markers, each marker representing a physical condition of the pipe system, and identify or predict a leak in the pipe system based on a specific combination of markers.

### BACKGROUND

### 1. Field

Aspects of the present disclosure generally relate to leak detection and prediction methods and systems for pipe systems, for example in connection with underground high pressure fluid filled (HPFF) or high pressure gas filled (HPGF) pipe systems.

### 2. Description of the Related Art

High pressure fluid filled pipe systems, herein also referred to as HPFF systems, comprise transmission cables or pipes, and are used for example in underground high voltage transmission systems, typically to a point where the transmission cables enter a major metropolitan area (for example, NY, Boston, Washington D.C., Chicago, London, Munich, Berlin, Paris, Delhi, etc.). The HPFF systems run for several miles, at times, more than 100 miles, some are over 200 miles. In the USA alone, statistics and papers estimate that there are >4,500 miles of underground high voltage HPFF systems.

In an example, a transmission cable or pipe includes a steel pipe that contains three high-voltage conductors. Each conductor is made of copper or aluminum, insulated with high-quality, oil-impregnated kraft paper insulation, and covered with metal shielding (usually lead) and skid wires (for protection during construction). Inside the steel pipe, three conductors are surrounded by a dielectric oil designed to be under high pressure (typical setpoints are from 10-13.8 bar or 150-200 psi) using pressurization plants (pump systems) every 1 or 2 kilometers (depending on the engineering design and city constraints). The fluid (dielectric oil) acts as an insulator and does not conduct electricity. The pressurized dielectric fluid prevents electrical discharges in the conductors' insulation. An electrical discharge can cause the line to fail. The fluid also transfers heat away from the conductors. The fluid is usually static and removes heat by conduction. In longer pipe runs, some pipe systems are installed with loops to circulate the dielectric oil with pumps to improve heat removal. The HPFF system is often described as a ‘living and breathing’ system, and due to current intensity (function of load demand) and oil/soil temperature or season of the year, the pressure of the HPFF system changes. To keep the pressure at the design setpoint, the system either relieves pressure into an oil tank reservoir or pumps oil from the reservoir to increase the pressure.

These HPFF systems have been developed and installed from the 1950's to about 2001, and the transmission pipes and cables tend to start leaking after the 7th year of operation. Today, there is an alternative for direct-buried XLPE cables which are non-pipe systems. However, Owners with existing HPFF pipe systems continue to repair the leaks or replace small sections of the system to maintain pipes in service because the costs to replace the entire pipe system with direct-buried technology are prohibitive, with negative Returns on Investment (ROI) which serve as a barrier to Utility Commission approval. Small leaks when left undetected lead to larger leaks of the dielectric oil which can result in the following consequences: (1) an environmental spill or hazard, with some HPFF systems running under rivers and streams, (2) an unplanned shutdown of a high voltage transmission feed which means residential and business, industrial and commercial loads are curtailed or shutdown (energy shortage potentially), (3) expensive to repair (complex process that entails the cryogenic freezing of the pipe system to isolate the section of the leak), and (4) repair work takes between 2 to 6 months depending on availability of required replacement hardware and labor.

### SUMMARY

A first aspect of the present disclosure provides a system for detection or prediction of a leak in a pipe system comprising a data source comprising characteristics of a pipe system, a prediction module, and an interface coupled between the data source and the prediction module, wherein the prediction module comprises at least one processor and is configured via executable instructions to receive the characteristics of the pipe system via the interface, evaluate the characteristics of the pipe system utilizing markers, each marker representing a physical condition of the pipe system, and identify or predict a leak in the pipe system based on a specific combination of markers.

A second aspect of the present disclosure provides a method for detection or prediction of a leak in a pipe system comprising, through operation of at least one processor, receiving characteristics of a pipe system from one or more data sources, evaluating the characteristics of the pipe system utilizing markers, each marker representing a physical condition of the pipe system, and identifying or predicting a leak in the pipe system based on a specific combination of markers.

A third aspect of the present disclosure provides a non-transitory computer readable medium encoded with processor executable instructions that when executed by at least one processor, cause at least one processor to carry out a method for detection or prediction of a leak in a pipe system as described herein.

### BRIEF DESCRIPTION OF THE DRAWINGS

FIG. 1 illustrates a schematic diagram of a system for detection or prediction of a leak in a pipe system in accordance with an exemplary embodiment of the present disclosure.

FIG. 2 illustrates a schematic diagram of a method for detection or prediction of a leak in a pipe system in accordance with an exemplary embodiment of the present disclosure.

FIG. 3 illustrates a schematic diagram of a system for detection or prediction of a leak in a pipe system including a digital twin of the pipe system in accordance with an exemplary embodiment of the present disclosure.

FIG. 4 illustrates a schematic diagram of a system for detection or prediction of a leak and localization of the leak in a pipe system in accordance with an exemplary embodiment of the present disclosure.

### DETAILED DESCRIPTION

To facilitate an understanding of embodiments, principles, and features of the present disclosure, they are explained hereinafter with reference to implementation in illustrative embodiments. In particular, they are described in the context of being systems and methods for detecting and/or predicting leaks in a pipe system, such as for example high pressure fluid filled (HPFF) or high pressure gas filled (HPGF) pipe systems. Embodiments of the present disclosure, however, are not limited to use in the described systems, devices or methods.

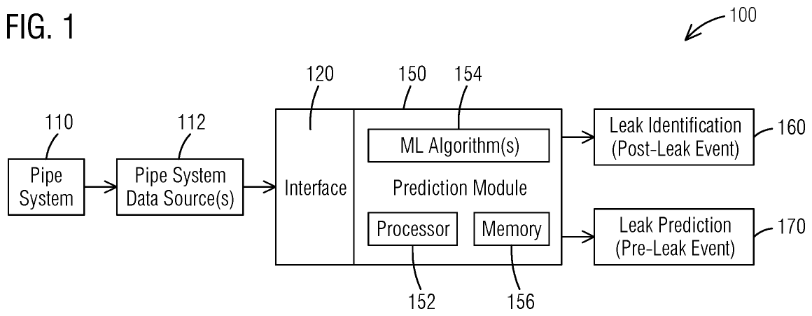

FIG. 1 illustrates a schematic diagram of a system 100 for detection or prediction of a leak in a pipe system in accordance with an exemplary embodiment of the present disclosure.

A pipe system 110 as used herein can be an underground high pressure fluid filled (HPFF) or high pressure gas filled (HPGF) pipe system. However, it should be noted that the described systems and methods are applicable to many other pipe systems, such as for example oil piping systems, water piping systems or piping systems of a power plant.

As described earlier, a HPFF pipe system includes a transmission cable or pipe with a steel pipe that contains high-voltage conductors. Inside the steel pipe, the conductors are surrounded by a dielectric oil designed to be under high pressure (typical setpoints are from 10-13.8 bar or 150-200 psi) using pressurization plants (pump systems) every 1 or 2 kilometers (depending on the engineering design and city constraints). The fluid (dielectric oil) acts as an insulator and does not conduct electricity. The fluid also transfers heat away from the conductors. The pressurized dielectric fluid prevents electrical discharges in the conductors' insulation. An electrical discharge can cause the line to fail.

According to an exemplary embodiment of the present disclosure, system 100 provides detection or prediction of one or more leaks in the pipe system 110. System 100 comprises one or more data source(s) 112 comprising a plurality of characteristics, data and information relating to the pipe system 110, such as for example the HPFF pipe system. The characteristics, data and information are herein referred to as pipe system data. The data source(s) 112 are digital data sources, such as digital files, online sites, or other data stores specific to the pipe system 110 to be analyzed.

The system 100 comprises an interface 120, coupled between the data source(s) 112 and prediction module 150, wherein the interface 120 is generally configured to provide, for example to transfer, the pipe system data of the pipe system 110 from the data source(s) 112 to the prediction module 150.

An interface as used herein, such as interface 120, comprises or includes a type of mechanism or device for providing, including for example transferring, moving, exchanging, data from a source, such as for example the data sources 112, to a target, such as for example prediction module 150.

An example for an interface is a computing interface or software implemented interface which defines interactions between multiple software intermediaries. An example for a computing interface is an application programming interface (API), wherein the API interacts with separate software components or resources for providing, e. g. transferring or exchanging, data in an automated manner from the data source(s) 112 to the target application. Another example for an interface includes collecting or obtaining data from the data source(s) 112 in a separate manual or automated step, and then, in a subsequent step, provide the collected data, for example export, transfer or upload, to the target application. In an example, data may be collected in an xlsx file and then uploaded in the target application.

In an embodiment of the present disclosure, the system 100 comprises a prediction module 150 comprising at least one processor 152 and a memory 156. In exemplary embodiments, the memory 156 may include any of a wide variety of memory devices including volatile and non-volatile memory devices, and the at least one processor 152 may include one or more processing units.

The memory 156 includes software with a variety of applications. One of the applications includes a method for identification/detection or prediction of leaks in the pipe system 110.

For this application, the at least one processor 152 is configured, via computer executable instructions, to receive pipe system data from the data source(s) 112 via the interface 120. In general, the prediction module 150 is configured to process received pipe system data and to identify or detect leaks, labelled as leak detection (post-leak event) 160, or to predict leaks, labelled as leak prediction (pre-leak event) 170, specifically to detect or predict small leaks in the pipe system 110. Small leaks as used herein refers to leaks in the pipe system 110 that may not be detectable or recognized by human operators and/or control systems tasked with monitoring specific parameters in the pipe system 110.

The collection or transfer of pipe system data can be integrated into the prediction module 150, e. g. performed by the prediction module 150, or can be separate process or module. The interface 120 may be part of the prediction module 150 or may be separate module. The collection of data can be recurrent in a scheduled manner.

The prediction module 150 is configured to evaluate or analyze the pipe system data of the pipe system 110 utilizing markers, wherein each marker represents a physical condition of the pipe system 110, and to identify or predict a leak in the pipe system 110 based on one or more specific combination(s) of markers. Identification means to identify or detect a leak that has occurred in the pipe system 110 (post-leak event, see 160).

Prediction means to forecast or predict a leak that is likely to happen or occur in the pipe system 110 within in a specified time (pre-leak event, see 170). In an embodiment, the identification or prediction of leaks is implemented utilizing Artificial Intelligence (AI), for example by one or more machine learning (ML) algorithm(s) or model(s) 154 utilizing specific input parameters.

The prediction module 150 may be embodied as software or a combination of software and hardware. The prediction module 150 may be a separate module or may be an existing module programmed to perform a method as described herein. For example, the prediction module 150 may be incorporated, for example programmed, into an existing pipe management/monitoring device, by means of software. Of course, the at least one processor 152 may be configured to perform only the process(es) described herein or can also be configured to perform other processes.

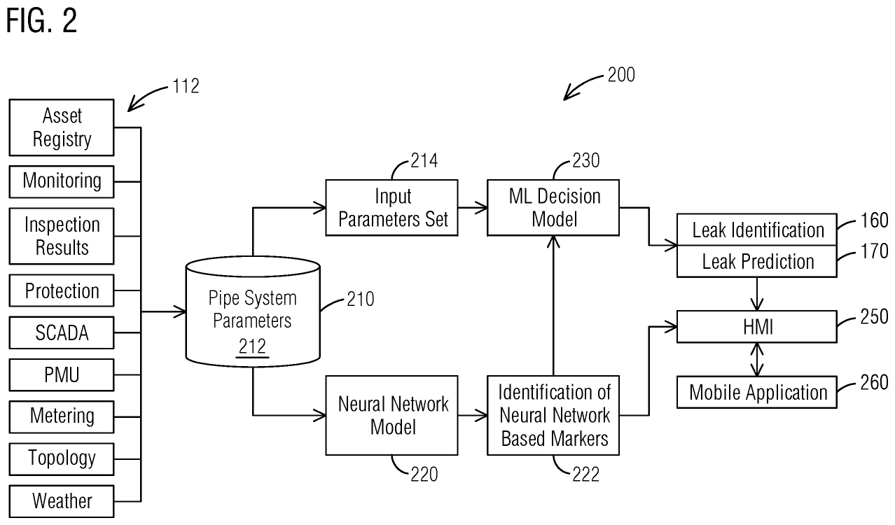

FIG. 2 illustrates a schematic diagram of a method 200 for detection or prediction of a leak in a pipe system in accordance with an exemplary embodiment of the present disclosure.

While the method 200 is described as a series of acts or steps that are performed in a sequence, it is to be understood that the method 200 may not be limited by the order of the sequence. For instance, unless stated otherwise, some acts may occur in a different order than what is described herein. In addition, in some cases, an act may occur concurrently with another act. Furthermore, in some instances, not all acts may be required to implement a methodology described herein.

In an embodiment of the present disclosure, the method 200 is performed utilizing the system 100 described with reference to FIG. 1. The method 200 comprises, through operation of at least one processor, such as for example processor 152 of prediction module 150, collecting pipe system data from a plurality of data sources 112, each data source 112 comprising pipe system data (characteristics, information, data) relating to the pipe system 110. Examples of data sources 112 of the pipe system 110 to be evaluated can include one or more of asset registry data, monitoring data, inspection results data, protection data, SCADA (supervisory control and data acquisition) information, PMU (phasor measurement unit) data, metering data, topology data, and weather data.

As noted, the pipe system data can be collected via an interface, such as interface 120. Collected and obtained pipe system data are stored in data store 210. The data store comprises pipe system data including pipe system parameters 212 with measured and/or simulated values of the pipe system parameters 212. Such pipe system parameters 212 include one or more of fluid parameters (such as dielectric fluid in the HPFF pipe system) including dielectric flow, fluid pressure, fluid temperature, fluid level in a reservoir or tank, cycling of a pump of a reservoir or tank as well as other parameters such as current flow and load of the (high-voltage) conductors and weather parameters. It should be noted that the pipe system parameters 212 may include many more parameters, depending on for example available data source(s) 112.

The pipe system data of the data store 210 are utilized and/or processed by the prediction module 150 to provide an identification and/or prediction service or method, see 160 and 170. The prediction module 150 comprises one or more ML model(s) or algorithm(s) 154 for identifying or predicting leaks in the pipe system 110.

In an exemplary embodiment of the present disclosure, the method 200 comprises evaluating or analyzing the pipe system data utilizing markers, wherein each marker represents a physical condition of the pipe system 110 and identifying or predicting a leak in the pipe system 110 based on one or more specific combination(s) of markers.

To identify or determine markers that represent physical conditions of the pipe system, a ML algorithm, specifically a neural network model 220, is implemented. In an example, the data-driven approach uses a LSTM (Long Short-Term Memory) recurrent neural network with feedback connections; this enables better anomaly detection and predictive capabilities when using time-series data.

The neural network model 220 is configured and continually being trained to find cross-correlations between at least two pipe system parameters 212. Specifically, the neural network model 220 is configured and trained to identify neural network based markers 222 in operational data (e. g. pipe system parameters, for example fluid temperature, fluid pressure, etc.) that correlate with physical commencement of a leak. In other words, the neural network model 220 finds cross-correlations between at least two parameters 212 that indicate a leak. For example, the model 220 may identify that a leak in the pipe system 110 occurs when a current or load (i) of pipe section A is i=x amps (Ampere) and a fluid pressure (p) in this pipe section A is p=y pascal (Pa). Many of such cross-correlation between two or multiple measured and/or simulated parameters 212 are identified by the neural network model 220. Over time, as the neural network model 220 is continually being trained, more cross-correlations may be found, and existing cross-correlations may be improved and are more accurate.

In an exemplary embodiment of the present disclosure, to identify or predict a leak in the pipe system 110, a ML decision model 230 is implemented. In an example, a Bayesian predictor using a generative deep learning model is implemented. Based on input pipe system data, specifically an input parameter set 214, which can be some or all parameters 212 of data store 210, and application of the neural network based markers 222, the ML decision model 230 is configured and trained to output a leak-no leak Boolean predictor. In other words, the ML decision model 230 produces a yes-no (1-0) output as to whether there is a leak in the pipe system 110 or not. With reference to the example above, a marker 222 indicates that a leak occurs at a current i=x amps and fluid pressure p=y Pa in pipe section A. The ML decision model 230 applies this marker 222 to the input parameter set 214 and ‘decides’ that a leak has occurred when the marker 222 of cross-correlation of fluid temperate and fluid pressure is met or present in the input parameter set 214. Further, the decision model 230 is configured to predict a leak when one or both parameters of the marker 222 are close to the specific values of the marker 222. Over time, as more data is ingested by the neural network model 220, the more reflective of real-world behavior it becomes and the more adept the ML decision model 230 becomes at identifying leaks and leak characteristics.

Output of the ML decision model 230 are provided via a Human-Machine-Interface (HMI) 250, for example via a graphical user interface, such as display or screen of a computer system, to a user or operator. Output of the ML decision model 230 can include identification 160 and/or prediction 170 of one or more leaks in the pipe system 110. Further, aspects of the identification of the neural network based markers 222 may also be provided via the HMI 250. Aspects or output of the neural network model 220 and markers 222 may include for example an asset health index or reliability index of the pipe system.

Further, in an embodiment, a user or operator, for example pipe system personnel, may access the leak identification and prediction output via a mobile application 260. The mobile application 260 may be a computer application installed on a mobile device, such as a tablet, smartphone, portable computer device etc. In an example, the application 260 stores computer executable instructions that, when executed by a computing device, e. g. mobile device, perform a method of accessing the HMI 250, and displaying, on a display of the mobile device, the post-leak event output 160 and pre-leak event output 170.

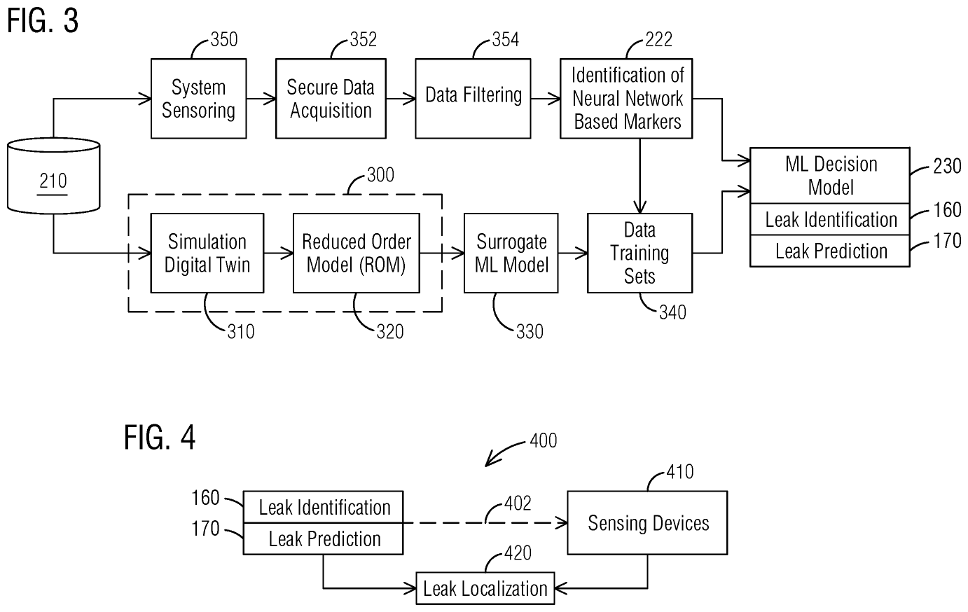

FIG. 3 illustrates a schematic diagram of a system for detection or prediction of a leak in a pipe system including a digital twin of the pipe system in accordance with an exemplary embodiment of the present disclosure.

In an embodiment of the present disclosure, a parallel and independent modelling methodology may be used in order to achieve a better confidence factor in leak identification and/or leak prediction. FIG. 3 illustrates an example of an independent modelling methodology which includes construction of a digital twin 300 of the pipe system 110. A digital twin is a virtual replica of a physical system or device that can be used for example to run simulations. In an embodiment, the digital twin 300 is built using both empirical data from field sensors and from computational fluid dynamic (CFD) simulations. CFD focuses on the use of fluid mechanics and numerical analysis to simulate the flow of fluid within the pipe and the interaction of the fluid with surfaces defined by boundary conditions. This variation of the digital twin 300, which is sometimes referred to as process twin or dynamic simulator, mirrors the operational behavior of the pipe system 110 or pipeline in near real-time. It serves as a virtual/digital replica of the pipe system and enables capabilities that would otherwise not be possible or sufficiently intractable, including the ability to rapidly run process and control engineering studies, investigate operating incidents, such as leaks, and explore “what-if” scenarios.

The digital twin 300 can provide a baseline for how the pipe system 110 behaves when it is in normal operation or steady state (i.e., with no leaks) and how it behaves right before and immediately after the occurrence of a leak. These behavioral changes are often too minute to be noticed by human operators; however, this is not the case for a learning model, e. g. the neural network model 220, which is trained to recognize patterns and data relationships that indicate that the pipe system 110 has moved into an abnormal or leak state.

In an exemplary embodiment, with the digital twin 300, a simulation 310 of the pipe system is performed, calibrated with available field data, for example from data store 210, such as pipe system parameters 212. Such a simulation 310 can be a 3-dimensional simulation of the pipe system. In another example, the simulation 310 may be a 1-dimensional simulation. A 1-dimensional simulation can be achieved with less time and costs but is a simplified simulation. A reduced-order model (ROM) 320 is created and utilized to capture flow behavior of a pipe leak and its influence with other system components (e. g., pump, tank, pressure, and temperature sensors, etc.). Based on the ROM 320, a surrogate ML model 330, for example a surrogate neural network model for identifying markers, is created.

In parallel to the digital twin 300, the method for detecting or predicting a leak is performed (see also FIG. 2). Some or all pipe system data of data store 210 are processed. Further system sensoring 350, for example high-frequency sampling of data sets, is performed. High-frequency sampling or scanning will be described in more detail below. Data sets are securely acquired, see 352, and, if necessary, filtered to reduce noise and errors, see 354. Neural network based markers 222 are identified, by the neural network model 220, and leaks detected or predicted by the ML decision model 230.

As FIG. 3 illustrates, the neural network based markers 222 may be used by the surrogate ML model 330, for example a surrogate neural network model, for training purposes to create data training sets 340, and in turn, the training data sets 340 are utilized by the ML decision model 230 for testing or demonstration purposes.

With respect to leak prediction, prediction capabilities can be derived from the digital twin 300 and rely on many of the same principles and methodologies used for leak detection (post-leak event) 160. A difference is where the neural network model 220, together with the collecting, (pre-)processing and analyzing the data sets, is being directed.

Whereas the post-leak detection focuses on being able to understand behavior of the pipe system 110 during both non-leak, normal operational state and inception of a leak, pre-leak detection focuses on understanding what happens during a time window prior to the leak occurring, i.e., as the system is transitioning in between normal, steady and abnormal operation. Such a transition can be referred to as leak conception period. The conception period offers a wealth of valuable information and by directing the neural network model 220, specific markers can be identified that correlate with a leak event that is likely to happen.

In an exemplary embodiment, high-frequency sampling, see for example system sensoring 350, of the pipe system parameters 212 is performed to predict a leak. In many cases, transition from steady to abnormal operational state of the pipe system 110 happens rapidly. Existing data collection systems that scan on a minute to minute basis often do not provide sufficient resolution to capture behavior of the pipe system 110 in its transition state. High-frequency sampling includes collecting data sets of the parameters 212 once per second (1 Hz) or even at a sampling frequency of up to 1,000 Hz.

FIG. 4 illustrates a schematic diagram of a system 400 for detection or prediction of a leak and localization of the leak in a pipe system in accordance with an exemplary embodiment of the present disclosure.

Having the capability to reliably detect (minor) leaks in the pipe system 110 is immensely valuable; however, it only represents one half of a solution. For a detected leak to be addressed before it becomes catastrophic, utilities (pipe system operator) need to locate the leak rapidly so that mitigating actions can be taken.

In an exemplary embodiment of the present disclosure, the system 400 comprises multiple sensing devices 410 to locate a leak in the pipe system 110, labelled leak localization 420. Specifically, location of leak is determined using non-destructive testing that relies on acoustic, for example ultrasonic, waves to propagate along a length of a specific section of the pipe system 110, for example a specific steel pipe section. Examples of sensing devices 410 include a guided wave sensor, such as an ultrasonic wave sensor, or a high-accuracy pressure transmitter whose signal can be scanned at frequency rates of up to 1,000 Hz.

One or more sensing devices, e. g. transducer(s), 410 are installed at predefined locations of pipes or transmission cables. Specifically, they are attached around the circumference of the specific pipe section in one or more locations, wherein the sensing devices 410 are mounted so that they cover an area where the pipe leak is suspected to occur or has occurred. Arrow 402 illustrates that information as to the area where the pipe leak has occurred or is suspected to occur is derived from the leak identification 160 or prediction 170 performed by the prediction module 150. Thus, the sensing devices 410 can be mounted in this specific area, or, if already multiple sensing devices 410 are installed within the pipe system 110, the respective sensing devices 410 activated. Further, the sensing devices 410 are ideally installed so that they can be easily be accessed by personnel (i.e. at termination stations).

When activating the sensing devices 410 and depending on the deployed sensing device 410, acoustic or pressure wave(s) propagate along the pipe section in both forward and backward directions. Waveforms, or disturbances, are generated at locations where there are geometric deformities in the pipe cross-section due to damage or corrosion. Based on the arrival time of the echoes or pressure waves, an approximate distance and extent of the deformity can be determined. Utilizing this technique, the location of the pipe leak or at least a narrow area where the leak is can be determined, see leak localization 420.

Further, output from a few sensing devices 410 is compared with the digital twin 300 of the pipe system 110 to indicate areas of the pipe system 110 where corrosion is growing with a risk-based factor to indicate the area or areas of most concern/criticality. This technique, in combination with the high-frequency sampling of pipe system parameters 212 (at 10 Hz to 1,000 Hz rates) on the sections of the pipe system 110 where the risk-based factors are highest, provides a greater confidence in the decision to raise an alert and a watch on, or predict an impending leak event.

With the provided systems and methods, leaks, in particular small leaks can be detected, and it is much easier to repair small leaks and an orderly shutdown can be planned. Further, potential occurrence of a leak can be predicted before the leak happens and an area or section of the pipe system 110 where a leak is most likely to occur can be identified so that a ‘watch’ can be implemented, i. e. the section monitored. Further, condition-based maintenance programs can be implemented, and service activities can be conducted in a more intelligent and targeted manner. For example, ‘watch lists’ can be developed so that plans can be put in place to address leaks that will likely occur in the future. In this way, response times can be shortened, and leaks can be dealt with proactively and orderly.

Further benefits of the leak detection and prediction systems and methods include for example:
Reduced unplanned downtime of pipe system, specifically transmission feeder(s), and potential loss of load, along with increased security of supply at times of high load/demand, especially at the height of summer,
Significantly lower repair costs,
Prevention of leaks and the resulting lower costs of environmental cleanup and remediation,
More efficient allocation of assets and manpower resources through condition-based maintenance,
Improved regulatory compliance through enhanced data transparency and reporting,
Improved environmental stewardship.

It should be appreciated that acts associated with the above-described methodologies, features, and functions (other than any described manual acts) may be carried out by one or more data processing systems, such as for example prediction module 150, via operation of at least one processor 152. As used herein, a processor corresponds to any electronic device that is configured via hardware circuits, software, and/or firmware to process data. For example, processors described herein may correspond to one or more (or a combination) of a microprocessor, CPU, or any other integrated circuit (IC) or other type of circuit that is capable of processing data in a data processing system. As discussed previously, the module 150 and/or processor 152 that is described or claimed as being configured to carry out a particular described/claimed process or function may correspond to a CPU that executes computer/processor executable instructions stored in a memory in form of software and/or firmware to carry out such a described/claimed process or function. However, it should also be appreciated that such a processor may correspond to an IC that is hard wired with processing circuitry (e.g., an FPGA or ASIC IC) to carry out such a described/claimed process or function.

In addition, it should also be understood that a processor that is described or claimed as being configured to carry out a particular described/claimed process or function may correspond to the combination of the module 150/processor 152 with the executable instructions (e.g., software/firmware apps) loaded/installed into a memory (volatile and/or non-volatile), which are currently being executed and/or are available to be executed by the processor to cause the processor to carry out the described/claimed process or function. Thus, a processor that is powered off or is executing other software, but has the described software installed on a data store in operative connection therewith (such as on a hard drive or SSD) in a manner that is setup to be executed by the processor (when started by a user, hardware and/or other software), may also correspond to the described/claimed processor that is configured to carry out the particular processes and functions described/claimed herein. Further, it should be understood, that reference to “a processor” may include multiple physical processors or cores that are configured to carry out the functions described herein.

It is also important to note that while the disclosure includes a description in the context of a fully functional system and/or a series of acts, those skilled in the art will appreciate that at least portions of the mechanism of the present disclosure and/or described acts are capable of being distributed in the form of computer/processor executable instructions (e.g., software and/or firmware instructions) contained within a data store that corresponds to a non-transitory machine-usable, computer-usable, or computer-readable medium in any of a variety of forms. The computer/processor executable instructions may include a routine, a sub-routine, programs, applications, modules, libraries, and/or the like. Further, it should be appreciated that computer/processor executable instructions may correspond to and/or may be generated from source code, byte code, runtime code, machine code, assembly language, Java, JavaScript, Python, Julia, C, C #, C++, Scala, R, MATLAB, Clojure, Lua, Go or any other form of code that can be programmed/configured to cause at least one processor to carry out the acts and features described herein. Still further, results of the described/claimed processes or functions may be stored in a computer-readable medium, displayed on a display device, and/or the like.

1. A system for detection or prediction of a leak in a pipe system comprising:
a data source comprising characteristics of a pipe system,
a prediction module, and
an interface coupled between the data source and the prediction module,
wherein the prediction module comprises at least one processor and is configured via executable instructions to
receive the characteristics of the pipe system via the interface,
evaluate the characteristics of the pipe system utilizing markers, each marker representing a physical condition of the pipe system, and
identify or predict a leak in the pipe system based on a specific combination of markers.

2. The system of claim 1, wherein the characteristics comprise pipe system parameters with measured and/or simulated values.

3. The system of claim 2, wherein the pipe system parameters are selected from fluid flow, fluid pressure, fluid temperature, fluid level in a reservoir or tank, cycling of a pump of a reservoir or tank, current flow, and a combination thereof.

4. The system of claim 1, wherein the prediction module comprises one or more machine learning (ML) algorithms.

5. The system of claim 4, wherein the prediction module is configured to identify the markers by implementing a neural network model, wherein each marker represents a cross-correlation between at least two pipe system parameters.

6. The system of claim 4, wherein the prediction module is configured to identify or predict the leak in the pipe system by implementing a Bayesian decision model.

7. The system of claim 2, wherein simulated pipe system parameters and values are derived from a digital twin of the pipe system.

8. The system of claim 1, further comprising:
a plurality of sensing devices mounted at pipes or cables at specific locations of the pipe system.

9. The system of claim 8, wherein the plurality of sensing devices comprises guided wave sensors or high-accuracy pressure transmitters.

10. The system of claim 1, further comprising:
a human machine interface (HMI), wherein the prediction module is configured to display, via the HMI, identified or predicted leaks of the pipe system.

11. A method for detection or prediction of a leak in a pipe system comprising, through operation of at least one processor:
receiving characteristics of a pipe system from one or more data sources,
evaluating the characteristics of the pipe system utilizing markers, each marker representing a physical condition of the pipe system, and
identifying or predicting a leak in the pipe system based on a specific combination of markers.

12. The method of claim 11, wherein the evaluating of the characteristics of the pipe system comprises identifying the markers by implementing a machine learning (ML) algorithm.

13. The method of claim 12, wherein the ML algorithm for identifying the markers comprises a neural network model.

14. The method of claim 11, wherein the identifying or predicting of the leak in the pipe system comprises implementing a ML decision model.

15. The method of claim 14, wherein the ML decision model comprises a Bayesian decision model.

16. The method of claim 11, further comprising:
displaying identified or predicted leaks and/or the markers on a display of a human machine interface (HMI).

17. The method of claim 11, further comprising:
receiving measured data provided by guided wave sensors mounted on pipes at specific locations of the pipe system, and
localizing identified leaks based on the measured data.

18. The method of claim 17, further comprising:
comparing the data provided by the guided wave sensors or high-accuracy pressure transmitters with a digital twin of the pipe system to indicate areas of corrosion including a risk-based factor.

19. The method of claim 18, further comprising:
high-frequency sampling of pipe system parameters in the areas of corrosion.

20. A non-transitory computer readable medium encoded with processor executable instructions that when executed by at least one processor, cause the at least one processor to carry out a method for identification or prediction of a leak in a pipe system as claimed in claim 11.
